(19) United States
(12) Patent Application Publication
(10) Pub. No.: US 2026/0354465 A1
(43) Pub. Date: Nov. 12, 2026

(54) AEROSOL GENERATING DEVICE AND HEATER FOR AEROSOL GENERATING DEVICE

(71) Applicant: SHENZHEN FIRST UNION TECHNOLOGY CO., LTD., Shenzhen, Guangdong (CN)

(72) Inventors: Wen ZENG, Shenzhen, Guangdong (CN); Liang PENG, Shenzhen, Guangdong (CN); Saisheng ZHU, Shenzhen, Guangdong (CN); Shuizhao HU, Shenzhen, Guangdong (CN); Hongsen CHENG, Shenzhen, Guangdong (CN); Jingsong HE, Shenzhen, Guangdong (CN); Wenbo ZHANG, Shenzhen, Guangdong (CN); Zexin WU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/119,635

(22) PCT Filed: Sep. 27, 2023
(86) PCT No.: PCT/CN2023/122205

§ 371 Date: Apr. 9, 2025

(30) Foreign Application Priority Data
Oct. 10, 2022 (CN) 202211235276.9

(51) Int. Cl. A24F 40/46; H05B 3/18

(52) U.S. Cl. CPC A24F 40/46; H05B 3/18

(57) ABSTRACT

An aerosol generating device is provided, configured to heat an aerosol generating article to generate an aerosol. The aerosol generating device includes: a heater, having a free front end and a tail end facing away from each other, and; a heating part, at least partially extending between the free front end and the tail end, to be inserted into the aerosol generating article for heating; a first annular element, surrounding or combined with the heating part; a second annular element, surrounding or combined with the heating part, where the second annular element and the first annular element are arranged spaced apart along a length direction of the heating part; and a base, at least partially molded between the first annular element and the second annular element around a part of the heating part by using a moldable material.

### CROSS-REFERENCE TO RELATED APPLICATIONS

This application claims priority to Chinese Patent Application No. 202211235276.9, filed with China National Intellectual Property Administration on Oct. 10, 2022 and entitled “AEROSOL GENERATING DEVICE AND HEATER FOR AEROSOL GENERATING DEVICE” which is incorporated herein by reference in its entirety.

### TECHNICAL FIELD

Embodiments of this application relate to the field of heat not burning aerosol generating technologies, and in particular, to an aerosol generating device and a heater for an aerosol generating device.

### BACKGROUND

Tobacco products (such as cigarettes and cigars) burn tobacco during use to produce tobacco smoke. Attempts are made to replace these tobacco-burning products by manufacturing products that release compounds without burning tobacco.

An example of this type of products is a heating device that releases compounds by heating rather than burning materials. For example, the materials may be tobacco or other non-tobacco products, where the non-tobacco products may or may not include nicotine. An existing heating device is inserted into the tobacco or other non-tobacco products through a resistive heater in a pin or needle shape for heating.

### SUMMARY

An embodiment of this application provides an aerosol generating device, configured to heat an aerosol generating article to generate an aerosol, including:
a heater, configured to heat the aerosol generating article, where the heater includes a free front end and a tail end facing away from each other along a length direction; and
a heating part, at least partially extending between the free front end and the tail end, to be inserted into the aerosol generating article for heating;
at least one annular element, surrounding or combined with the heating part; and
a base, at least partially surrounding the heating part, and being arranged to provide structural support for the heating part to keep the heating part in the aerosol generating device, where the base includes a combining part coupled to an outer surface of the heating part, and the combining part abuts against the annular element along the length direction of the heating part, to prevent the base from moving relative to the heating part along the length direction of the heating part.

In some implementations, the heating part includes:
a housing, at least partially extending between the free front end and the tail end, where a first cavity is disposed in the housing; and
a resistive heating coil, located in the first cavity.

In some implementations, the resistive heating coil is constructed to be a solenoid coil; and
an extension size of a cross section of a wire material of the resistive heating coil in an axial direction is greater than an extension size of the cross section in a radial direction.

In some implementations, the at least one annular element includes a metal or an alloy.

In some implementations, a color of an outer surface of the at least one annular element is different from a color of the outer surface of the heating part.

In some implementations, an extension size of the at least one annular element along the length direction of the heating part is 0.5 to 2 mm; and/or
the extension dimension of the at least one annular element along the length direction of the heating part is less than an extension dimension of the base along the length direction of the heating part.

In some implementations, a wall thickness of the annular element is 0.1 to 0.5 mm.

In some implementations, the base is molded around a part of the heating part by using a moldable material, to couple the base to the heating part.

In some implementations, the base includes an organic polymer.

In some implementations, the at least one annular element is flush with the tail end.

In some implementations, the base includes a first surface near or facing toward the free front end; and
the at least one annular element is surrounded in the base, and is flush with the first surface.

In some implementations, a distance between the at least one annular element and the tail end is greater than 0.5 mm.

In some implementations, the base includes a first surface near or facing toward the free front end; and
the at least one annular element partially extends from inside the base to outside the first surface.

In some implementations, the base is further provided with:
one or more connecting parts arranged circumferentially around the base, where the base is fixedly connected to the aerosol generating device through the connecting part.

In some implementations, the at least one annular element at least includes:
a first annular element and a second annular element, arranged spaced apart along a length direction of the heating part, where the combining part is at least partially located between the first annular element and the second annular element.

In some implementations, the base includes:
an inner side wall near or at least partially combined with the heating part, and an outer side wall facing away from the inner side wall; and
at least one second cavity, located between the inner side wall and the outer side wall, to provide thermal insulation between the inner side wall and the outer side wall.

In some implementations, the base includes a first side near or facing toward the free front end, and a second side facing away from the first side; and
the at least one second cavity is open on the second side, and the at least one second cavity is closed on the first side.

In some implementations, no gap exists between the combining part and the heating part; and/or a gap between the combining part and the heating part is less than 0.05 mm.

In some implementations, the base includes a first surface near or facing toward the free front end; and
an angle between a central axis of the heating part and a normal line perpendicular to the first surface is less than 1°.

In some implementations, in an axial direction of the resistive heating coil, the resistive heating coil includes a first end near the free front end, and a second end near the tail end; and
the heating part further includes: a first conductive pin and a second conductive pin configured to supply electricity to the resistive heating coil, where
the first conductive pin is connected to the first end, and at least partially extends from the first end beyond the tail end;

the second conductive pin is connected to the second end, and at least partially extends from the second end beyond the tail end; and
a spacing between the first conductive pin and the second conductive pin is in a range from 0.7 mm to 0.9 mm.

In some implementations, the aerosol generating device further includes:
a battery cell, configured to supply electricity; and
a circuit, configured to control the battery cell to provide power to the heater, to keep a temperature of a part of the heating part surrounded by the base less than 340 °C.

Another embodiment of this application further provides an aerosol generating device, configured to heat an aerosol generating article to generate an aerosol, including:
a heater, configured to heat the aerosol generating article, where the heater includes a free front end and a tail end facing away from each other along a length direction; and
a heating part, at least partially extending between the free front end and the tail end, to be inserted into the aerosol generating article for heating;
at least one annular element, surrounding or bound to the heating part; and
a base, molded around a part of the heating part and the at least one annular element by using a moldable material, to couple the base to the heating part and the at least one annular element.

Another embodiment of this application further provides an aerosol generating device, configured to heat an aerosol generating article to generate an aerosol, including:
a heater, configured to heat the aerosol generating article, where the heater includes a free front end and a tail end facing away from each other along a length direction, and
a heating part, at least partially extending between the free front end and the tail end, to be inserted into the aerosol generating article for heating;
a first annular element, surrounding or combined with the heating part;
a second annular element, surrounding or combined with the heating part, where the second annular element and the first annular element are arranged spaced apart along a length direction of the heating element; and
a base, at least partially molded between the first annular element and the second annular element and around a part of the heating part by using a moldable material.

Another embodiment of this application further provides an aerosol generating device, configured to heat an aerosol generating article to generate an aerosol, including:
a heater, configured to heat the aerosol generating article, where the heater includes a free front end and a tail end facing away from each other along a length direction; and
a housing, at least partially extending between the free front end and the tail end, to be inserted into the aerosol generating article;
a resistive heating coil, accommodated and held in the housing;
at least one groove or concave cavity, defined by an outer surface of the housing; and arranged around the housing along a peripheral direction of the housing; and
a base, molded around a part of the housing by using a moldable material, and at least partially extending into the at least one groove or concave cavity, to prevent the base from moving relative to the housing along a length direction of the housing.

Another embodiment of this application further provides an aerosol generating device, configured to heat an aerosol generating article to generate an aerosol, including:
a heater, configured to heat the aerosol generating article, where the heater includes a free front end and a tail end facing away from each other along a length direction; and
a heating part, at least partially extending between the free front end and the tail end, to be inserted into the aerosol generating article for heating;
a base, at least partially surrounding or combined with the heating part; where the aerosol generating device holds the heater by using the base; and the base includes:
an inner side surface surrounding or combined with the heating part, and an outer side surface facing away from the inner side surface; and
at least one second cavity, located between the inner side surface and the outer side surface, to reduce transfer of heat of the heating part to the outer side surface.

Another embodiment of this application further provides a heater for an aerosol generating device, where the heater includes a free front end and a tail end facing away from each other along a length direction, and
a heating part, at least partially extending between the free front end and the tail end, to be inserted into an aerosol generating article for heating;
at least one annular element, surrounding or bound to the heating part; and
a base, at least partially surrounding the heating part, to provide structural support for the heating part, where the base includes a combining part coupled to an outer surface of the heating part, and the combining part abuts against the at least one annular element along the length direction of the heating part, to prevent the base from moving relative to the heating part along the length direction of the heating part.

Another embodiment of this application further provides a heater for an aerosol generating device, where the heater includes a free front end and a tail end facing away from each other along a length direction, and
a heating part, at least partially extending between the free front end and the tail end, to be inserted into an aerosol generating article for heating;
a base, at least partially surrounding or combined with the heating part, to provide structural support for the heating part, where the base includes:
an inner side surface surrounding or combined with the heating part, and an outer side surface facing away from the inner side surface; and
at least one second cavity, located between the inner side surface and the outer side surface, to reduce transfer of heat of the heating part to the outer side surface.

Another embodiment of this application further provides an aerosol generating device, configured to heat an aerosol generating article to generate an aerosol, including:
a heater, configured to heat the aerosol generating article, where the heater includes a free front end and a tail end facing away from each other along a length direction; and
a heating part, at least partially extending between the free front end and the tail end, to be inserted into the aerosol generating article for heating;
a base, at least partially surrounding the heating part, and being arranged to provide structural support for the heating part to keep the heating part in the aerosol generating device, where
the base includes a first surface near or facing toward the free front end; and
an angle between a central axis of the heating part and a normal line perpendicular to the first surface is less than 1°.

An aerosol generating device is provided, configured to heat an aerosol generating article to generate an aerosol, and including:
a heater, configured to heat the aerosol generating article, where the heater includes:
a heating part, configured to be inserted into the aerosol generating article for heating, and having a free front end and a tail end facing away from each other along a length direction; and
a base, molded around a part of the heating part by using a moldable material, and arranged to provide structural support for the heating part, where a spacing exists between the base and the tail end of the heating part, so that a stair is defined between the base and the heating part near the tail end; and
the spacing between the base and the tail end of the heating part is greater than 0.5 mm.

According to the foregoing aerosol generating device, the heater facilitates providing a stop for the base by using the annular element outside the heating part.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an aerosol generating device according to an embodiment;

FIG. 2 is a schematic structural diagram of a heater in FIG. 1 from a perspective;

FIG. 3 is a schematic exploded view of the heater in FIG. 2 from a perspective;

FIG. 4 is a schematic cross-sectional view of the heater in FIG. 2 from a perspective;

FIG. 5 is a schematic structural diagram of a base according to another embodiment;

FIG. 6 is a schematic diagram of a housing according to another embodiment;

FIG. 7 is a schematic structural diagram of a heater according to another embodiment;

FIG. 8 is a schematic structural diagram of a heater according to another embodiment;

FIG. 9 is a schematic structural diagram of a heater according to another embodiment;

FIG. 10 is a schematic structural diagram of a heater according to another embodiment;

FIG. 11 is a schematic structural diagram of a mold for molding a base outside a housing according to an embodiment;

FIG. 12 is a schematic diagram of clamping models; and

FIG. 13 is a schematic diagram of demolding after a base is molded.

### DETAILED DESCRIPTION

For ease of understanding of this application, this application is described below in more detail with reference to the accompanying drawings and specific implementations.

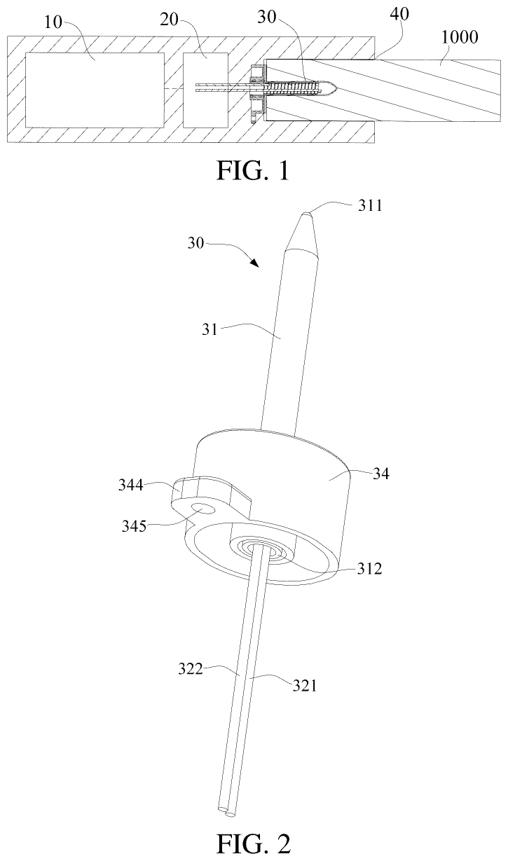

An embodiment of this application provides an aerosol generating device. For a structure thereof, refer to FIG. 1. The aerosol generating device includes:
a chamber, having an opening 40, where during use, an aerosol generating article 1000 is removably received in the chamber through the opening 40 of the chamber;
a heater 30 at least partially extending in the chamber, inserted into the aerosol generating article 1000 for heating when the aerosol generating article 1000 is received in the chamber, so that the aerosol generating article 1000 releases a plurality of volatile compounds, where the volatile compounds are formed by heating only;
a battery cell 10, configured to supply electricity; and
a circuit 20, configured to guide a current between the battery cell 10 and the heater 30.

In a preferred embodiment, a direct current supply voltage provided by the battery cell 10 ranges from about 2.5 V to about 9.0 V, and an amperage of a direct current that the battery cell 10 can provide ranges from about 2.5 A to about 20 A.

In a preferred embodiment, the heater 30 is substantially in a shape of a pin, a needle, a bar, a rod, a column, a sheet, or a plate, which facilitates insertion into the aerosol generating article 1000. In addition, the heater 30 may have a length of about 12 to 20 millimeters, and an outer diameter of about 2 to 4 millimeters.

Further, in an optional implementation, the aerosol generating article 1000 is preferably made of a tobacco-containing material that releases a volatile compound from a substrate when being heated, or a non-tobacco material suitable for electric heating and smoking after being heated. The aerosol generating article 1000 preferably uses a solid substrate. The solid substrate may include one or more of powders, particles, fragmented strips, strips, or slices of one or more of vanilla leaves, tobacco leaves, homogeneous tobacco, and expanded tobacco. Alternatively, the solid substrate may include additional tobacco or non-tobacco volatile aroma compounds to be released when the substrate is heated.

During implementation, the heater 30 may usually include a resistive heating element and auxiliary base materials assisting in fixing and preparing the resistive heating element. For example, in some implementations, the resistive heating element is in a shape or form of a spiral coil. Alternatively, in some other implementations, the resistive heating element is in a form of a conductive track that is combined on the substrate. Alternatively, in some other implementations, the resistive heating element is in a shape of a slice.

Further, FIG. 2 to FIG. 4 are schematic diagrams of a heater 30 according to an embodiment. The heater 30 in this embodiment includes a free front end 311 and a tail end 312 that are opposite along a length direction. The free front end 311 is a conical tip, to be inserted into the aerosol generating article 1000. Specifically, the heater 30 includes:
a housing 31, configured into an external shape of a pin, a needle, a column, or a bar, where two opposite ends of the housing 31 along a length direction respectively define a free front end 311 and a tail end 312 of the heater 30; and the housing 31 has a cavity 313 extending between the free front end 311 and the tail end 312. The cavity 313 forms an opening or an exposure at the tail end 312, to facilitate assembly of each functional component inside the cavity 313.

In some embodiments, the housing 31 is heat-conducive; and the housing 31 is made of a heat-conductive material. The housing 31 may be made of ceramic such as aluminum ceramic or zirconium ceramic, or may be made of glass, or may be made of metal or alloy such as iron-aluminum alloy or stainless steel.

In this embodiment, the cavity 313 of the housing 31 is provided with:
a resistive heating coil 32; and
a conductive pin 321 and a conductive pin 322, respectively connected to two ends of the resistive heating coil 32, to supply electricity to the resistive heating coil 32, where the conductive pin 321 and the conductive pin 322 at least partially extend from inside the cavity 313 to outside the tail end 312, which facilitates connection to the circuit 20. In addition, the conductive pin 321 is connected to an upper end of the resistive heating coil 32 in a manner such as soldering, and extends through the resistive heating coil 32 to outside the tail end 312. The conductive pin 322 is directly connected to a lower end of the resistive heating coil 32 in a manner such as soldering. The conductive pin 321 and the conductive pin 322 have a diameter of about 0.1 to 0.5 mm. Alternatively, in some specific embodiments, the conductive pin 321 and the conductive pin 322 have a diameter of 0.3 mm.

During implementation, the housing 31 and the resistive heating coil 32 held in the housing 31 form a heating part configured to be inserted into the aerosol generating article 1000 for heating.

Alternatively, in some other variant embodiments, a rod-shaped heating component defines the heating part configured to be inserted into the aerosol generating article 1000 for heating. For example, the heating component may further include: a rod-shaped electrically isolating substrate such as ceramic or a polymer, and a resistive heating track formed or combined on the electrically isolating substrate.

In some implementations, the housing 31 has an outer diameter of about 2.0 to 2.8 mm, and a wall thickness of about 0.1 to 0.3 mm. Therefore, an inner diameter of the cavity 313 of the housing 31 is about 1.5 to 2.1 mm, and a length of the cavity 313 is about 12 to 15 mm.

In an optional implementation, the resistive heating coil 32 is made of a metal material with an appropriate impedance, a metal alloy, graphite, carbon, conductive ceramic, or another composite material of a ceramic material and a metal material. A suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, iron-manganese-aluminum based alloy, or stainless steel. Certainly, after assembly, the resistive heating coil 32 and an inner wall of the cavity 313 of the housing 31 are insulated from each other. In addition, during use, the housing 31 receives or transfers heat of the resistive heating coil 32 to heat the aerosol generating article 1000. In some embodiments, an insulation layer is formed on the surface of the resistive heating coil 32 through spraying, deposition, or surface oxidation, to cause the resistive heating coil 32 to be insulated from the inner wall of the cavity 313 of the housing 31.

In addition, in some embodiments, the conductive pin 321 and/or the conductive pin 322 have a diameter of about 0.1 to 0.5 mm; and the conductive pin 321 and/or the conductive pin 322 have a length of about 20 to 40 mm. Moreover, the conductive pin 321 and/or the conductive pin 322 are made of a metal or an alloy with a low electrical resistance, for example, gold, silver, copper, or an alloy including gold, silver, or copper. Alternatively, in some other embodiments, the conductive pin 321 and/or the conductive pin 322 are a copper wire or a copper conductor having a plated layer such as a nickel layer on the surface. Alternatively, in some other embodiments, the conductive pin 321 and/or the conductive pin 322 may further be sprayed or coated with an insulation layer, for example, a ceramic layer, an enamel layer, or an organic layer beneficial to insulation. For example, in some embodiments, a Teflon insulation tube is sleeved on the conductive pin 321 and/or the conductive pin 322, which facilitates providing insulation. In addition, the conductive pin 321 and the conductive pin 322 are spaced apart; a spacing between the conductive pin 321 and the conductive pin 322 is 0.8 mm±0.1 mm; or a spacing between the conductive pin 321 and the conductive pin 322 is from 0.7 mm to 0.9 mm.

In addition, the resistive heating coil 32 is not in contact with the aerosol generating article 1000.

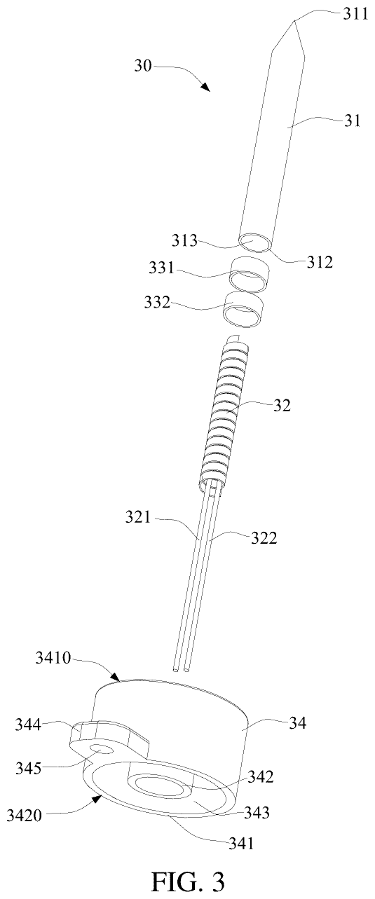

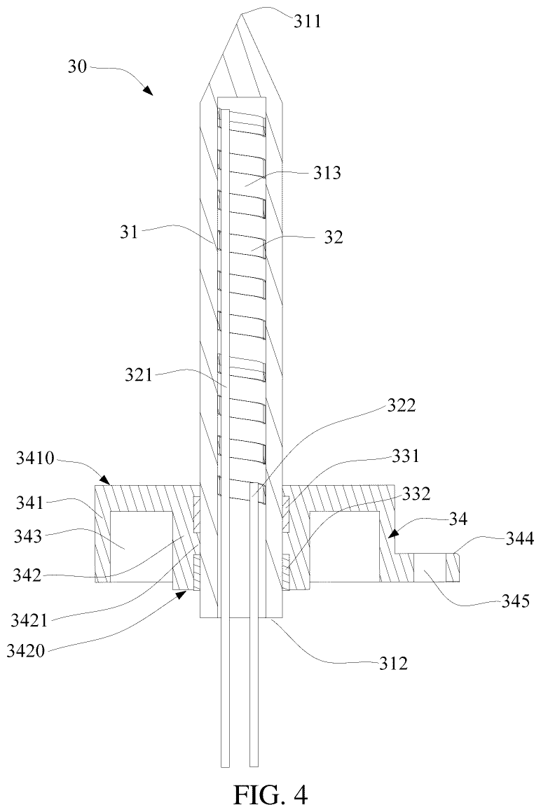

In embodiments shown in FIG. 3 and FIG. 4, a cross-sectional shape of a wire material of the resistive heating coil 32, which is configured in a form of a solenoid coil, is a shape different from a regular circle. In the implementations shown in FIG. 3 and FIG. 4, a cross section of the wire material of the resistive heating coil 32 has a size extending in an axial direction that is greater than a size extending in a radial direction perpendicular to the axial direction, so that the cross section of the resistive heating coil 32 is in a flat rectangular shape.

Simply, comparing the resistive heating coil 32 constructed above with a conventional spiral heating coil formed by a wire with a circular cross section, the wire material is completely or at least flattened in form. Therefore, the wire material extends to a small extent in the radial direction. In this way, energy loss in the resistive heating coil 32 can be reduced. Particularly, this promotes transfer of heat generated by the resistive heating coil 32 to the housing 31 in the radial direction.

Alternatively, in some other variant embodiments, the cross section of the wire material of the resistive heating coil 32 is in a shape of a circle.

In addition, further referring to FIG. 2, the heater 30 further includes:
a base 34, at least partially surrounding or combined on the housing 31. The base 34 is basically arranged near the tail end 312, and the aerosol generating device clamps or holds the base 34, so that the heater 30 is stably mounted and fixed in the device. In addition, the base 34 basically avoids the resistive heating coil 32. Alternatively, the base 34 is basically located at an end of the resistance heating coil 32 near the tail end 312. Alternatively, in some other embodiments, the base 34 is closer to the tail end 312 than the resistive heating coil 32 is. Alternatively, in some other embodiments, the base 34 is arranged in a staggered manner relative to the resistive heating coil 32 along a length of the heater 30. Alternatively, in some other embodiments, a spacing between the base 34 and the resistive heating coil 32 along the length of the heater 30 is greater than 1 mm.

In some embodiments, the base 34 is independently prepared, and then is combined on the housing 31 in a manner such as riveting or mechanical fixing.

Alternatively, in some other embodiments, the base 34 is molded around the housing 31 by using a moldable material. The base 34 is made of an organic polymer such as PEEK, polytetrafluoroethylene, polyurethane, or a polyester resin, or is made of a moldable material such as ceramic.

In addition, in some embodiments, the circuit 20 controls electricity provided by the battery core 21 to the heater 30, so that during use, a temperature of a part of the heating part and/or the housing 31 surrounded by the base 34 is less than 340 °C. Alternatively, in some other embodiments, during operation, a temperature of a part of the heating part and/or the housing 31 surrounded by the base 34 is less than 320 °C.

In addition, further referring to FIG. 2 to FIG. 4, the base 34 has a first side 3410 and a second side 3420 facing away from each other along a longitudinal direction. During implementation, the first side 3410 faces toward or is near the free front end 311, and the second side 3420 faces toward or is near the tail end 312. Moreover, after assembly, a surface of the first side 3410 of the base 34 is flush with an inner bottom wall of the chamber that faces away from the opening 40. Moreover, after assembly, at least a part of the surface of the first side 3410 of the base 34 is exposed to the chamber.

The surface of the first side 3410 of the base 34 is substantially perpendicular to a central axis of the housing 31 and/or the heating part. Alternatively, in some embodiments, an angle between the central axis of the housing 31 and/or the heating part and a normal line perpendicular to the surface of the first side 3410 of the base 34 is less than 1°. Alternatively, in some embodiments, the angle between the central axis of the housing 31 and/or the heating part and the normal line perpendicular to the surface of the first side 3410 of the base 34 is less than 0.5°.

In addition, further referring to FIG. 2 to FIG. 4, the base 34 includes:
an outer side wall 341 and an inner side wall 342 facing away from each other in the radial direction; where the outer side wall 341 defines an outer surface that surrounds the base 34 along a peripheral direction, and the inner side wall 342 defines an inner surface that surrounds the housing 31; and
a cavity 343, located between the outer side wall 341 and the inner side wall 342; where the cavity 343 is closed on the first side 3410, and the cavity 343 is open on the second side 3420.

Moreover, the outer side wall 341 and the inner side wall 342 are connected at the first side 3410 and are not connected at the second side 3420. Moreover, space in the cavity 343 is filled with air, to at least prevent heat of the housing 31 from being transferred to the outer side wall 341. Alternatively, the cavity 343 is configured to provide thermal insulation.

In some embodiments, the base 34 has an outer contour shape of approximately a circle, a square, a polygon, or the like.

In addition, further referring to FIG. 2 to FIG. 4, the second side 3420 of the base 34 is basically flush with the tail end 312 of the housing 31.

Moreover, in some embodiments, an extension size of the base 34 along a longitudinal direction of the heater 30 is 3 to 6 mm.

Further, referring to FIG. 2 to FIG. 4, the base 34 further includes:
one or more connecting parts 344 arranged around the base 34 and/or the outer side wall 341 along a peripheral direction, where the connecting part 344 may be provided with a fastening structure such as a screw hole 345, a connecting hole, or a connecting slot, and during assembly, a screw, a hook, or the like is fitted with the fastening structure such as the screw hole 345 of the connecting part 344, to fasten the base 34 and/or the heater 30 in the aerosol generating device.

In the embodiments shown in FIG. 2 to FIG. 4, the connecting part 344 extends from the outer side wall 341 along the radial direction, the connecting part 344 is convex relative to the outer side wall 341, and the screw hole 345 runs through the connecting part 344 along a longitudinal direction of the base 34.

In the embodiment shown in FIG. 4, the inner side wall 342 is slightly more convex than the outer side wall 341 on the second side 3420. For example, in FIG. 4, the inner side wall 342 exceeds the outer side wall 341 by 0.4 mm on the second side 3420. Alternatively, in some implementations, the outer side wall 341 and the inner side wall 342 are flush at the second side 3420. Alternatively, in some other embodiments, the outer side wall 341 is slightly more convex than the inner side wall 342 on the second side 3420.

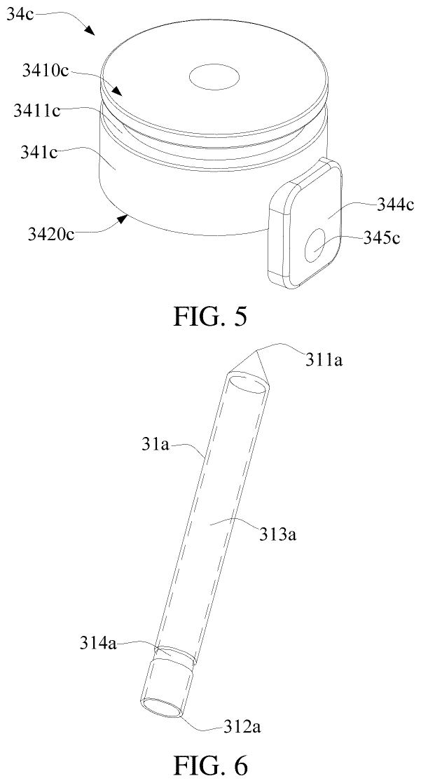

Alternatively, FIG. 5 is a schematic diagram of a base 34c according to another variant embodiment. In this embodiment, the base 34c includes:
an outer side wall 341c, where a slot 3411c is defined on the outer side wall 341c, and the slot 3411c surrounds the outer side wall 341c and/or the base 34c in a peripheral direction. During assembly, the aerosol generating device at least partially extends into the slot 3411c, to prevent the base 34c from moving in an axial direction. In addition, the aerosol generating device at least partially extends into the slot 3411c, so that the base 34 and/or the heater 30 can also be fastened in the aerosol generating device in a compressing manner.

Alternatively, in the embodiment shown in FIG. 5, the base 34c further includes:
a connecting part 344c extending from the outer side wall 341c to outside the second side 3420c; where there may be one or more connecting parts 344c, and a plurality of connecting parts 344c may alternatively be arranged around the outer side wall 341c in the peripheral direction. The connecting part 344c is convex relative to the second side 3420c along the longitudinal direction. In addition, during assembly, the screw hole 345c in the connecting part 344c is screwed, to fasten the base 34c and/or the heater 30 in the aerosol generating device.

In addition, further referring to FIG. 2 to FIG. 4, the heater 30 further includes:
at least one annular element, for example, an annular element 331 and an annular element 332, surrounding and combined on at least a part of the outer surface of the housing 31. In addition, the annular element 331 and the annular element 332 are arranged spaced apart along a longitudinal direction of the housing 31.

In addition, the inner side wall 342 of the base 34 has a part 3421 that is snapped between the annular element 331 and the annular element 332. Further, after assembly, the part 3421 abuts against the annular element 331 and/or the annular element 332 along the longitudinal direction. Alternatively, the part 3421 is clamped by the annular element 331 and the annular element 332. Therefore, the annular element 331 and the annular element 332 are configured to prevent the base 34 from moving relative to the housing 31 along the longitudinal direction of the housing 31.

There is no gap between the part 3421 of the base 34 that is molded and the outer surface of the housing 31, or a gap or a spacing is less than 0.05 mm. If the part 3421 of the base 34 is separately prepared and then is riveted or mechanically fixed to the outer surface of the housing 31, there may be an assembly gap of 0.05 mm. In comparison, the part 3421 is more stably in contact with the annular element 331 and/or the annular element 332 according to the manner in this embodiment.

In some implementations, the annular element 331 and the annular element 332 are combined on the outer surface of the housing 31 in a manner such as riveting.

In some implementations, the annular element 331 and the annular element 332 are made of a metal or alloy material such as stainless steel, brass, aluminum alloy, or titanium alloy.

In some specific implementations, the annular element 331 and/or the annular element 332 have a color different from that of the outer surface of the housing 31. For example, the housing 31 is made of stainless steel, and the outer surface of the housing 31 is of a silver color; and the annular element 331 and/or the annular element 332 are made of brass, and the annular element 331 and/or the annular element 332 are yellow. During preparation, it is advantageous that an equipment identifies and locates locations of the annular element 331 and/or the annular element 332, and then assembles and prepares the base 34 around the annular element 331 and/or the annular element 332.

In addition, during implementation, the base 34 completely surrounds the annular element 331 and/or the annular element 332. In other words, after assembly, the annular element 331 and/or the annular element 332 do not extend out or are not exposed outside the base 34. Moreover, the annular element 331 is closer to the first side 3410 of the base 34, and the annular element 332 is closer to the second side 3420 of the base 34.

In addition, further referring to FIG. 4, after assembly, the annular element 331 and/or the annular element 332 are surrounded or encircled by the inner wall of the base 34, and the annular element 331 and/or the annular element 332 is wrapped or covered by the base 34. For example, in the implementation shown in FIG. 4, the surface of the first side 3410 of the base 34 is closer to the free front end 311 than the annular element 331 is.

Moreover, in some embodiments, the annular element 332 is closer to the tail end 312 than the annular element 331 is; the annular element 332 is close to or located at the tail end 312 of the housing 31; in FIG. 4, the annular element 332 is basically spaced from the tail end 312 of the housing 31; and a spacing between the annular element 332 and the tail end 312 of the housing 31 is greater than or equal to 0.5 mm.

Moreover, in some embodiments, extension sizes of the annular element 331 and/or the annular element 332 along the axial direction are the same. In some specific embodiments, the extension sizes of the annular element 331 and/or the annular element 332 along the axial direction are 0.5 to 2 mm. In addition, in some embodiments, a spacing between the annular element 331 and the annular element 332 is 0.5 to 1 mm.

In addition, in some embodiments, wall thicknesses of the annular element 331 and the annular element 332 are 0.1 to 0.5 mm. An outer side surface of the annular element 331 and/or the annular element 332 is convex relative to an outer side surface of the housing 31, and a convex height is 0.1 to 0.5 mm.

Alternatively, in some other variant embodiments, extension sizes of the annular element 331 and the annular element 332 along the axial direction are different. For example, an extension size of the annular element 331 along the axial direction is greater than an extension size of the annular element 332 along the axial direction.

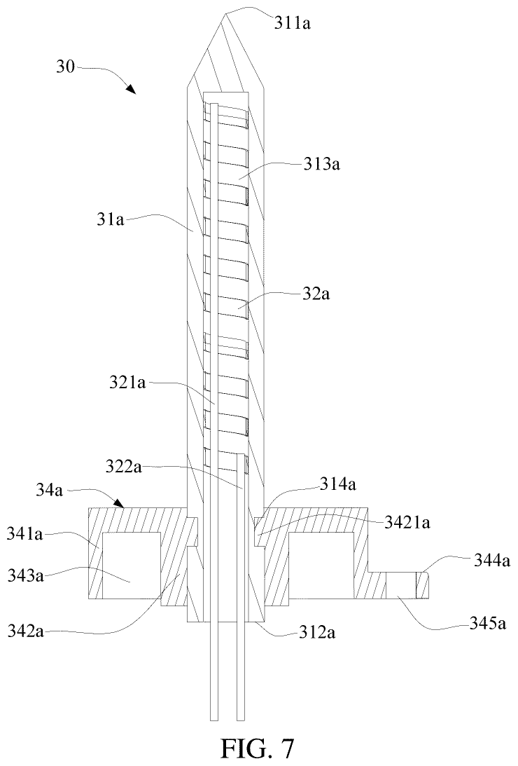

Further, FIG. 6 and FIG. 7 are schematic diagrams of a heater 30 according to another embodiment. In this embodiment, the heater 30 includes:
a housing 31a, where at least one groove or concave cavity 314a surrounding the housing 31a is formed on an outer surface of the housing 31a, and the housing 31a is near the tail end 312a; and
a base 34a, surrounding or combined on the housing 31a, where an inner side wall 342a of the base 34a has a part 3421a that extends into or snaps into the groove or concave cavity 314a.

Further, after assembly, the part 3421a extends into or snaps into the groove or concave cavity 314a, thereby facilitating preventing the base 34a from moving relative to the housing 31a along a longitudinal direction of the housing 31a.

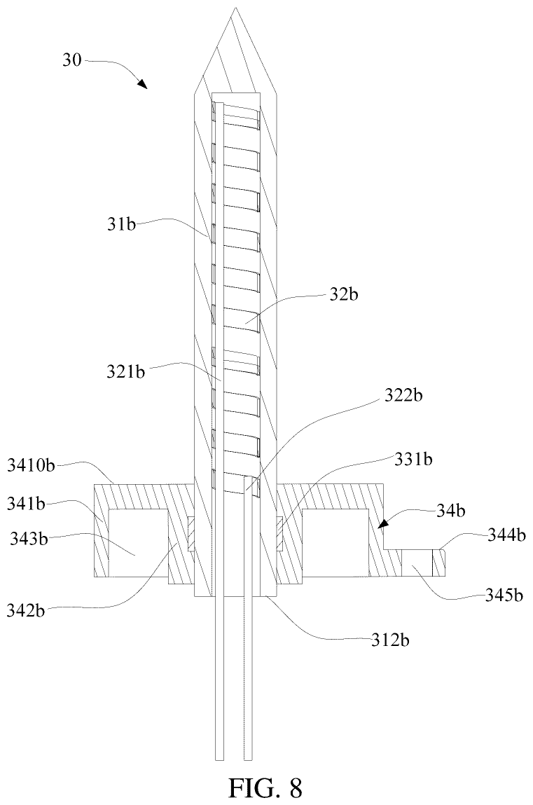

Alternatively, FIG. 8 is a schematic diagram of a heater 30 according to another variant embodiment. In this embodiment, the heater 30 includes:
a housing 31b, where the housing 31b has only one annular element 331b, and the annular element 331b may be formed on an outer surface of the housing 31b in a manner such as riveting; and
a base 34b, surrounding and combined on the housing 31b, where the base 34b surrounds the annular element 331b, and further, after assembly, the annular element 331b prevents the base 34b from moving relative to the housing 31b along a longitudinal direction of the housing 31b.

The annular element 331b is located between a first side 3410b and a second side 3420 of the base 34b. There is a spacing between the annular element 331b and a tail end 312b, and there is a spacing between the annular element 331b and the first side 3410b.

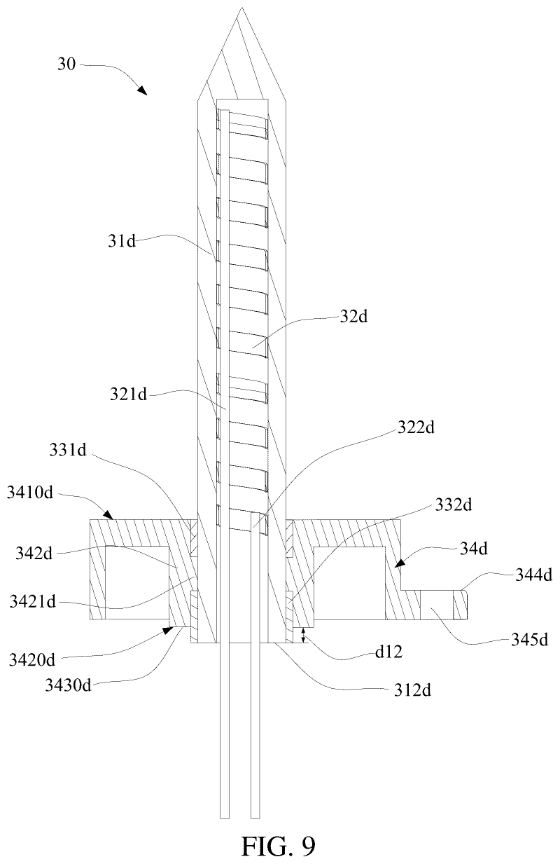

Alternatively, FIG. 9 is a schematic diagram of a heater 30 according to another variant embodiment. In this embodiment, the heater 30 includes:
a housing 31d, defining a free front end 311d and a tail end 312d facing away from each other;
an annular element 331d and an annular element 332d, spaced apart and successively combined outside the housing 31d, where an extension length of the annular element 331d along an axial direction is greater than an extension length of the annular element 332d along the axial direction, the annular element 332d is closer to the tail end 312d than the annular element 331d is, and a spacing between the annular element 332d and the tail end 312d is maintained to be greater than or equal to 0.5 mm, or in some other embodiments, the annular element 332d may be flush with the tail end 312d; and
a base 34d, surrounding and combined on the housing 31d, where the base 34d completely surrounds the annular element 331d and completely surrounds the annular element 332d, and an inner side wall 342d of the base 34d has a part 3421d extending between the annular element 332d and the annular element 331d, to prevent the base 34d from moving relative to the housing 31d in a longitudinal direction.

Moreover, in this embodiment, the annular element 331d is flush with the first side 3410d of the base 34d, and the annular element 332d is flush with the second side 3420d of the base 34d. The annular element 331d is flush with the first side 3410d of the base 34d, and this is beneficial to precise control and positioning of an injection amount of an injection-molding material in a process of molding the base 34d.

Moreover, in this embodiment, there is a distance d12 between the base 34d and the tail end 312d of the housing 31d, and the distance d12 is greater than 0.5 mm. Further, during implementation, a stair 3430d is defined between the base 34d and the tail end 312d of the housing 31d. During molding, an equipment or a model completes material injection of the base 34d at the position, and this facilitates preventing molding slurry from overflowing out of the tail end 312d during the injection process, and improving verticality between the second side 3420d of the base 34d and the housing 31d. In addition, during implementation, the stair 3430d facilitates solidification and demolding of the base 34d.

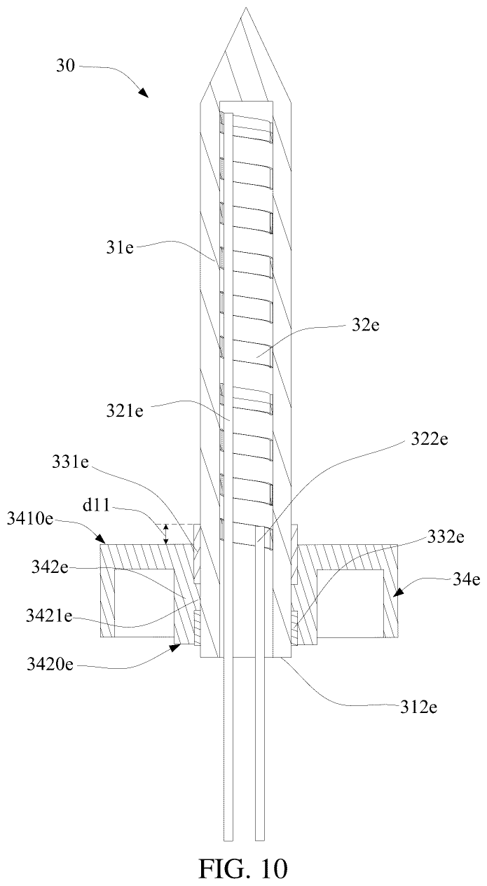

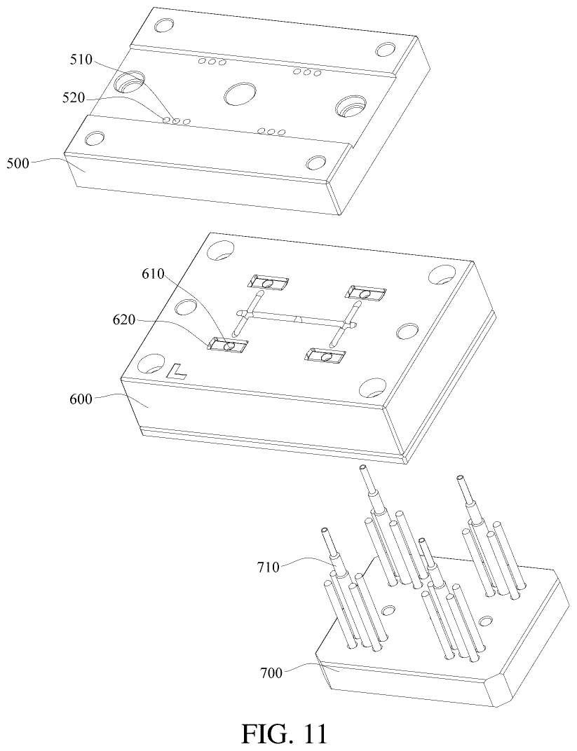

Alternatively, FIG. 10 is a schematic diagram of a heater 30 according to another variant embodiment. In this embodiment, the heater 30 includes:
a housing 31e, defining a free front end 311e and a tail end 312e facing away from each other;
an annular element 331e and an annular element 332e, spaced apart and successively combined outside the housing 31e, where an extension length of the annular element 331e along an axial direction is greater than an extension length of the annular element 332e along the axial direction, the annular element 332e is closer to the tail end 312e than the annular element 331e is, and a spacing may be maintained between the annular element 332e and the tail end 312e, or the annular element 332d may be flush with the tail end 312d; and
a base 34e, surrounding and combined on the housing 31e, where the base 34e surrounds a part of the annular element 331e and completely surrounds the annular element 332e, and an inner side wall 342e of the base 34e has a part 3421e extending between the annular element 332e and the annular element 331e, to prevent the base 34e from moving relative to the housing 31e in a longitudinal direction.

In addition, after assembly, at least a part of the annular element 331e is convex relative to the first side 3410e of the base 34e, or at least a part of the annular element 331e extends out or is exposed outside the first side 3410e of the base 34e.

In addition, in an embodiment, a length or size d11 by which the annular element 331e extends out or is exposed outside the first side 3410e of the base 34e is 1.0 to 2.0 mm. For example, in a specific embodiment, the length d11 by which the annular element 331e extends out of the first side 3410e of the base 34e is 1.3 mm. This facilitates preventing the base 34e from scraping a bare surface of the housing 31e near the free front end 311e during assembly or preparation.

Further, FIG. 11 to FIG. 13 are schematic diagrams of molding a base 34 outside a housing 31 by using a model according to an embodiment. As shown in the figure, the model includes an upper model 500, a lower model 600, and a movable jig 700.

A surface of the lower model 600 facing toward the upper model 500 has a holding cavity 610 for accommodating and holding the housing 31, and a shaping cavity 620 surrounding the holding cavity 610 for injection-molding of the base 34.

A tubular support member 710 is disposed on the movable jig 700, and the housing 31 is inserted into the support member 710 to be held; and the support member 710 of the movable jig 700 passes through from a lower side of the lower model 600 to an upper side of the holding cavity 610.

In some embodiments, after the movable jig 700 and the lower model 600 are assembled, the support member 710 always passes through to the upper side of the holding cavity 610, and this is convenient to assemble the housing 31 on the support member 710. After assembly, the movable jig 700 is then moved downward, until the housing 31 held on the support member 710 is moved to a predetermined position in the holding cavity 610.

Then, the upper model 500 and the lower model 600 are clamped, and the upper model 500 closes the shaping cavity 620.

In addition, an avoidance hole 510 is provided on the upper model 500, to enable the housing 31 held in the holding cavity 610 to be inserted in when the models are clamped; and an injection opening 520 is provided on the upper model 500, and the injection opening 520 is in communication with the shaping cavity 620, so that a moldable material for forming the base 34 is injected to the shaping cavity 620 through the injection opening 520, and the moldable material is solidified outside the housing 31 to form the base 34.

Referring to FIG. 11, the model clamping process includes the following steps.

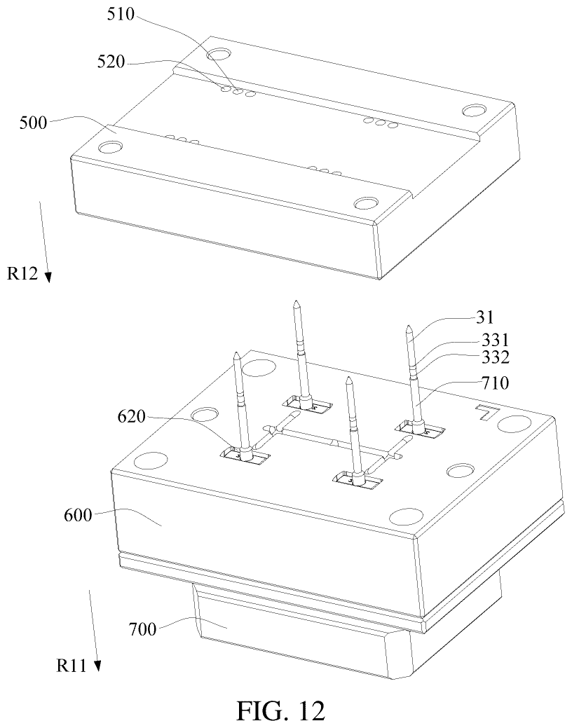

The movable jig 700 is first moved downward as shown by an arrow R11 in FIG. 12, so that the housing 31 on the support member 710 is moved to a predetermined position in the holding cavity 610.

Then, as shown by an arrow R12 in FIG. 12, the upper model 500 is moved to the lower model 600 to close the cavity 620, and then injection may be performed.

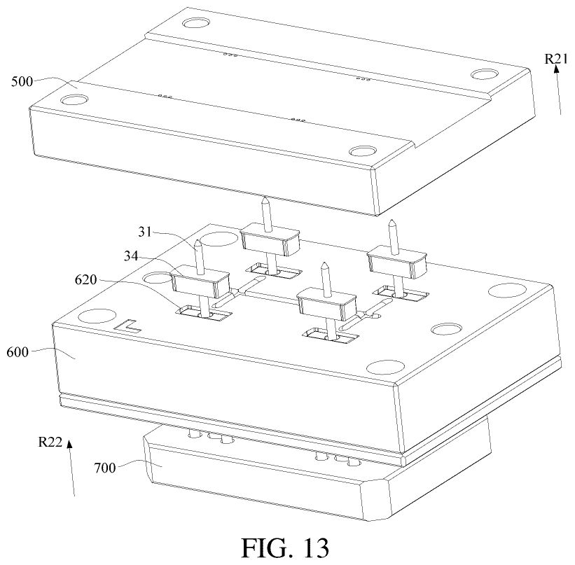

Referring to FIG. 13, the demolding process includes the following steps.

The upper model 500 is first separated from the lower model 600 as shown by an arrow R21 in FIG. 13, to open the shaping cavity 620.

Then, the jig 700 is moved as shown by an arrow R22 in FIG. 13, to eject the housing 31 in which the base 34 is molded from the shaping cavity 620 from an upper side; and then, the housing 31 in which the base 34 is molded is extracted from the support member 710 of the jig 700, to obtain the heater 30.

In addition, during implementation, the annular element 331 and the annular element 332 outside the housing 31 can further be configured to position the movable jig 700 in a movement process.

Moreover, in some implementations, a tolerance or an error control of a wall thickness of a tube wall of the housing 31 is less than 0.015 mm, and this facilitates preventing flashing and sagging during injection and demolding processes in molding the base 34.

It should be noted that, the specification of this application and the accompanying drawings thereof illustrate preferred embodiments of this application, but are not limited to the embodiments described in this specification. Further, a person of ordinary skill in the art may make improvements or modifications according to the above descriptions, and such improvements and modifications shall all fall within the protection scope of the appended claims of this application.

1. An aerosol generating device, configured to heat an aerosol generating article to generate an aerosol, and comprising:
a heater, configured to heat the aerosol generating article, wherein the heater comprises a free front end and a tail end facing away from each other along a length direction; and
a heating part, at least partially extending between the free front end and the tail end, to be inserted into the aerosol generating article for heating;
at least one annular element, surrounding or combined with the heating part; and
a base, at least partially surrounding the heating part, and being arranged to provide structural support for the heating part to keep the heating part in the aerosol generating device, wherein the base comprises a combining part coupled to an outer surface of the heating part, and the combining part abuts against the annular element along the length direction of the heating part, to prevent the base from moving relative to the heating part along the length direction of the heating part.

2. The aerosol generating device according to claim 1, wherein the heating part comprises:
a housing, at least partially extending between the free front end and the tail end, wherein a first cavity is disposed in the housing; and
a resistive heating coil, located in the first cavity.

3. The aerosol generating device according to claim 2, wherein the resistive heating coil is constructed to be a solenoid coil; and
an extension size of a cross section of a wire material of the resistive heating coil in an axial direction is greater than an extension size of the cross section in a radial direction.

4. The aerosol generating device according to claim 1, wherein the at least one annular element comprises a metal or an alloy.

5. The aerosol generating device according to claim 1, wherein a color of an outer surface of the at least one annular element is different from a color of the outer surface of the heating part.

6. The aerosol generating device according to claim 1, wherein an extension size of the at least one annular element along the length direction of the heating part is 0.5 to 2 mm; and/or
the extension dimension of the at least one annular element along the length direction of the heating part is less than an extension dimension of the base along the length direction of the heating part.

7. The aerosol generating device according to claim 1, wherein a wall thickness of the annular element is 0.1 to 0.5 mm.

8. The aerosol generating device according to claim 1, wherein the base is molded around a part of the heating part by using a moldable material, to couple the base to the heating part.

9. The aerosol generating device according to claim 8, wherein the base comprises an organic polymer.

10. The aerosol generating device according to claim 1, wherein the at least one annular element is flush with the tail end.

11. The aerosol generating device according to claim 1, wherein a distance between the at least one annular element and the tail end is greater than 0.5 mm.

12. The aerosol generating device according to claim 1, wherein the base comprises a first surface near or facing toward the free front end; and
the at least one annular element is surrounded in the base, and is flush with the first surface.

13. The aerosol generating device according to claim 1, wherein the base comprises a first surface near or facing toward the free front end; and
the at least one annular element partially extends from inside the base to outside the first surface.

14. The aerosol generating device according to claim 1, wherein the base is further provided with:
one or more connecting parts arranged circumferentially around the base, wherein the base is fixedly connected to the aerosol generating device through the connecting part.

15. The aerosol generating device according to claim 1, wherein the at least one annular element at least comprises:
a first annular element and a second annular element, arranged spaced apart along a length direction of the heating part, wherein the combining part is at least partially located between the first annular element and the second annular element.

16. The aerosol generating device according to claim 1, wherein the base comprises: an inner side wall near or at least partially combined with the heating part, and an outer side wall facing away from the inner side wall; and
at least one second cavity, located between the inner side wall and the outer side wall, to provide thermal insulation between the inner side wall and the outer side wall.

17. The aerosol generating device according to claim 16, wherein the base comprises a first side near or facing toward the free front end, and a second side facing away from the first side; and
the at least one second cavity is open on the second side, and the at least one second cavity is closed on the first side.

18. The aerosol generating device according to claim 1, wherein no gap exists between the combining part and the heating part; and/or
a gap between the combining part and the heating part is less than 0.05 mm.

19. The aerosol generating device according to claim 1, wherein the base comprises a first surface near or facing toward the free front end; and
an angle between a central axis of the heating part and a normal line perpendicular to the first surface is less than 1°.

20-25. (canceled)

26. A heater for an aerosol generating device, wherein the heater comprises a free front end and a tail end facing away from each other along a length direction, and
a heating part, at least partially extending between the free front end and the tail end, to be inserted into an aerosol generating article for heating;
at least one annular element, surrounding or bound to the heating part; and
a base, at least partially surrounding the heating part, to provide structural support for the heating part, wherein the base comprises a combining part coupled to an outer surface of the heating part, and the combining part abuts against the at least one annular element along the length direction of the heating part, to prevent the base from moving relative to the heating part along the length direction of the heating part.

27-32. (canceled)
